(19) United States
(12) Patent Application Publication
(10) Pub. No.: US 2010/0325179 A1
(43) Pub. Date: Dec. 23, 2010

(54) SYSTEM AND METHOD FOR ANALYZING VOTERS

(76) Inventor: Scott Robert Tranter, Washington, DC (US)

Correspondence Address: HAMRE, SCHUMANN, MUELLER & LARSON, P.C., P.O. BOX 2902, MINNEAPOLIS, MN, 55402-0902, US

(21) Appl. No.: 12/864,415

(22) PCT Filed: Jan. 26, 2009
(86) PCT No.: PCT/US09/31971

§ 371 Date: Jul. 23, 2010

Related U.S. Application Data
(60) Provisional application No. 61/023,286, filed on Jan. 24, 2008.

(51) Int. Cl. G06F 17/30

(52) U.S. Cl. 707/821; 707/E17.005

(57) ABSTRACT

Systems and methods for generating a voter profile is disclosed. The systems and methods include creating a client data having a client attribute and a sensitivity score, providing a database having a voter identification, a question, and an answer, then translating the answer into a voter score. The voter score is compared to client data to generate a voter profile. The voter profile is used to generate a targeted message specifically designed for the voter.

### PRIORITY INFORMATION

This application is being filed as a PCT International Patent Application in the name of Scott Robert Tranter and claims the benefit of priority of U.S. Provisional Patent Application No. 61/023,286 filed Jan. 24, 2008 and entitled “SYSTEM AND METHOD FOR ANALYZING VOTERS,” which is hereby incorporated by reference in its entirety.

### BACKGROUND OF THE INVENTION

People have historically relied on accurate and timely information to make decisions and the reliance on the information is even more pronounced in modern management environments. Businesses and organizations have been historically sought out new ways to maximize the use of their limited resources. For political campaigns, receiving a maximum return for investment in the campaign is especially important, because generally political campaigns have a limited life span to obtain the limited resources. Because of a limited life span of a political campaign, speed on the return of the investment can also be important. Because of these and other reasons, political campaigns have historically been limited to sending a collection of only general information to voters. Often the information is not specific enough to a voter. Often the information misses to mention what a voter believes is an important issue. For example, a 24 year-old voter with student loans may consider a government's position on education loans to be an important issue, while a 56 year-old voter with a $60K mortgage may consider other issues to be more important. Further, issues considered important to the same 56 year-old voter may not be considered important to another 56 year-old voter who has outright ownership of two homes. Accordingly, there is a need for an improved system and method for being able to deliver and address specific issues to a particular individual voter.

### BRIEF SUMMARY OF THE INVENTION

A system and method of generating a voter profile, comprises the steps of creating a client data having a client attribute and a sensitivity score; providing a database having a set of data; the set of data having a voter attribute; the voter attribute having a voter identification, a question, and an answer; creating an association between the client attribute and the question; translating the answer into a voter score; performing an algorithm using the voter score and the sensitivity score to calculate a distance score; and generating a voter profile, wherein the voter profile includes the voter identification, the client attribute, the voter score, and the distance score.

In addition, the system and methods may further include the steps of providing a score range associated with the client attribute, the score range having a plurality of score values; comparing the voter score to the plurality of score values to determine a match score; providing a message associated with the match score; associating the message associated with the match score to the voter identification; and generating a targeted message report, wherein the targeted message report includes the voter identification and the message associated with the match score.

Alternatively, the system and methods may further include providing a distance score range associated with the client attribute; providing a message associated with the distance score range; comparing the distance score to the distance score range to determine a match range; associating the message associated with the distance score range to the voter identification; and generating a targeted message report, wherein the targeted message report includes the voter identification and the message associated with the distance score range.

A voter profile may also include information from data-mining public information. The method of including such information includes gathering a set of data; creating a database from the gathered set of data, wherein the gathered data has a public data field, and a public data value; translating the public data value into a new voter score; and generating the voter profile to further include the new voter score. Further, a score range associated with a client attribute may be provided, wherein the score range having a plurality of score values. Then a comparison may be made between the new voter score to the plurality of score values to determine a match score. The match score is used to generate a targeted message report.

Further systems and methods for generating a voter profile prediction are disclosed herein. The systems and methods include the steps of providing a client data having a client attribute and a database having a set of data, wherein the set of data has a voter attribute; the voter attribute having a first score and a second score; and a scheme for generating a third score from a prediction algorithm using the first score and the second score. The third score is used in creating an updated voter attribute, which in turn is used in generating the voter profile prediction. A targeted message report may be generated using the updated voter attribute.

A system capable of performing the methods includes a data server and a front-end server. The front-end server may generate a client interface, wherein the client interface includes receiving client data and receiving a voter profile request, wherein the front-end server communicates the voter profile request to the data server and then the data server generates a voter profile. The system may further include a data server having an instruction set including a prediction algorithm. The system may include a message server, wherein the data server communicates the voter profile to the message server and the message server generates a targeted message report. The front-end server, data server, and message server may all be part of one machine or device. A database sequestration scheme configured to store a first client data separately from a second client data may be also included in any of the systems discussed herein.

In an embodied method of generating a voter profile, the method comprises storing a client data on a computer readable medium, wherein the client data includes a client attribute and a sensitivity score. The embodied method includes storing a database on the computer readable medium, wherein the database includes a set of data, wherein the set of data includes a voter attribute, wherein the voter attribute includes a voter identification, a question, and an answer. The embodied method further includes creating an association between the client attribute and the question, storing the association on the computer readable medium, translating the answer into a voter score, storing a computer instruction on the computer readable medium, wherein the computer instruction includes an algorithm that uses the voter score and the sensitivity score to calculate a distance score. The embodied method further includes performing the computer instruction of the algorithm to calculate the distance score, generating a voter profile, wherein the voter profile includes the voter identification, the client attribute, the voter score, and the distance score, and storing the voter profile on the computer readable medium.

In another embodied method, the method further includes storing a score range associated with the client attribute on the computer readable medium, and storing a message associated with a match score on the computer readable medium, wherein the score range includes a plurality of score values.

In an embodiment, the computer instruction includes a step of comparing the voter score to the plurality of score values for determining the match score, a step of determining the match score, a step of storing the match score on the computer readable medium, a step of associating the message to the voter identification, and a step of generating a targeted message report, wherein the targeted message report includes the voter identification, and the message.

In another embodied method, the method includes storing a distance score range associated with the client attribute on the computer readable medium, and storing a message associated with the distance score range on the computer readable medium.

In an embodiment, the computer instruction includes a step of determining a match range by comparing the distance score to the distance score range, a step of storing the match range, a step of associating the message to the voter identification, and a step of generating a targeted message report, wherein the targeted message report includes the voter identification, and the message.

In another embodiment, the method includes gathering a second set of data, creating a second database from the second set of data, wherein the second set of data includes a public attribute, wherein the public attribute includes a public data field, and a public data value, and translating the public data value into a second voter score, wherein the voter profile further includes the second voter score.

In another embodiment, the method includes storing a score range associated with the client attribute on the computer readable medium, wherein the score range includes a plurality of score values, and storing a message associated with a match score on the computer readable medium.

In an embodiment, the computer instruction includes a step of comparing the second voter score to the plurality of score values to determine the match score, a step of associating the message to the voter identification, and a step of generating a targeted message report, wherein the targeted message report includes the voter identification, and the message.

In another embodiment, the method includes creating an association between the question and the public data field, and storing the association on a computer readable medium.

In an embodiment, the computer instruction includes a step of determining a third voter score from the voter score and the second voter score.

In the embodiment, the voter profile further includes the third voter score.

In another embodiment, the method includes storing a score range associated with the client attribute on a computer readable medium, wherein the score range includes a plurality of score values, and storing a message associated with a match score on the computer readable medium.

In an embodiment, the computer instruction includes a step of comparing the third voter score to the plurality of score values for determining the match score, a step of determining the match score, a step of associating the message to the voter identification, and a step of generating a targeted message report, wherein the targeted message report includes the voter identification, and the message.

In another embodiment, there is a method of generating a voter profile prediction, wherein the method comprises storing a client data including a client attribute on a computer readable medium, storing a database including a set of data on the computer readable medium, wherein the set of data includes a voter attribute, wherein the voter attribute includes a first score, and a second score. The embodiment includes storing a score range associated with the client attribute on the computer readable medium, wherein the score range includes a plurality of score values. The embodiment further includes storing a message associated with a match score on a computer readable medium, storing a computer instruction for voter profile prediction on the computer readable medium.

In an embodiment, the computer instruction includes a step of generating a third score from a prediction algorithm using the first score and the second score, a step of creating an updated voter attribute from the voter attribute and the third score, a step of generating the voter profile prediction from the updated voter attribute, a step of comparing the third score to the plurality of score values to determine the match score, and a step of generating a targeted message report, wherein the targeted message report includes a voter identification, and the message.

In another embodiment, there is a system for generating a voter profile. The system includes a data server, and a front-end server that communicates a display data via a network to a remote computer, wherein the remote computer includes a display device that displays a client interface in accordance to the display data, wherein the client interface is configured to communicate client data and a voter profile request via the network to the front-end server, wherein the front-end server communicates the voter profile request to the data server, wherein the data server generates a voter profile and stores the voter profile on a computer readable medium.

In an embodiment of a system, the data server includes the computer readable medium.

In an embodiment of a system, the computer readable medium includes a computer program, wherein, the computer program includes a prediction algorithm, wherein the prediction algorithm includes a step of generating a third score by using the first score and the second score, a step of creating an updated voter attribute from a voter attribute and the third score, a step of generating a voter profile prediction from the updated voter attribute, and a step of comparing the third score to a plurality of score values to determine a match score.

In an embodiment of a system, the system includes a message server that generates a targeted message report, wherein the targeted message report includes a voter identification, and a message, wherein the data server communicates the voter profile to the message server.

In an embodiment of a system, the system includes a database sequestration scheme configured to store a first client data separately from a second client data.

### BRIEF DESCRIPTION OF THE SEVERAL VIEWS OF THE DRAWINGS

FIG. 1 shows an embodiment of a Client Data table.

FIG. 2 shows an embodiment of a Voter Attribute table.

FIG. 3 shows an embodiment of a Voter Profile table.

FIG. 4 shows an embodiment of a system.

FIG. 5 shows an embodiment of a system.

### DETAILED DESCRIPTION OF THE INVENTION

In the following and above, the term “people” is defined to include one or more person and/or legal entity. Also in the following and above, the term “voter” is defined to include one or more person and/or entity, who may have voted and/or may vote in the future, and/or may have an influence or may contribute in any way to a campaign. The term “computer readable medium” includes devices configures to function as random access memory, read only memory, flash memory, magnetic memory devices, such as hard drives, optical memory devices, such as CD-ROM, CD-R, CD-RW, DVD, DVD-R, and variants of devices configured to store digital information. The term “computer readable medium” includes memory buffers, videocard memory and/or buffers, and any plurality of devices that are connected via a wired and/or wireless connection configured to share data is also defined herein as a computer readable medium. Accordingly, as a example, a series of computers each having a hard drive, wherein the plurality of the computers are connected along a network connection, as a whole, as defined herein, is a computer readable medium. The term “generating” is defined to include forming and/or arranging information in digital data format or on a tangible medium, such as paper. The term “gathering” is defined to include digital data-mining, sorting digital data, arranging digital data, entering data into digital format, or any combinations thereof. The term “creating” is defined to include forming a link, forming an association, and the like. For example, forming an association between a set of data, using a pointer to make a digital connection between memory addresses, or other variants, would be “creating” an association. The term “translation” is defined to include replacing a set of data to another set of data. Replacing a “Yes” to a numerical value of “1” and replacing a “No” to a numerical value of “0” are examples of “translation” as defined herein. Replacing a numerical value with a non-numerical character is also an example of “translation” as defined herein. The term “delivering” is defined herein to include sending data, for example, sending data for display on a display device via a network. The term “network” is defined herein to include a wired network, for example, such as LAN, optical connection, electrical connection. The term “network” also includes a wireless network, for example, such as WiFi, 3G, infrared, Bluetooth, radio, etc. The term “network” also includes the internet. A “client interface” is defined to include a web page, a plurality of web pages, a portion of a web page, configured to be displayed on a display device. The “client interface” may be displayed using a web browser software. The “client interface” may be a client software that operates with a server side server software.

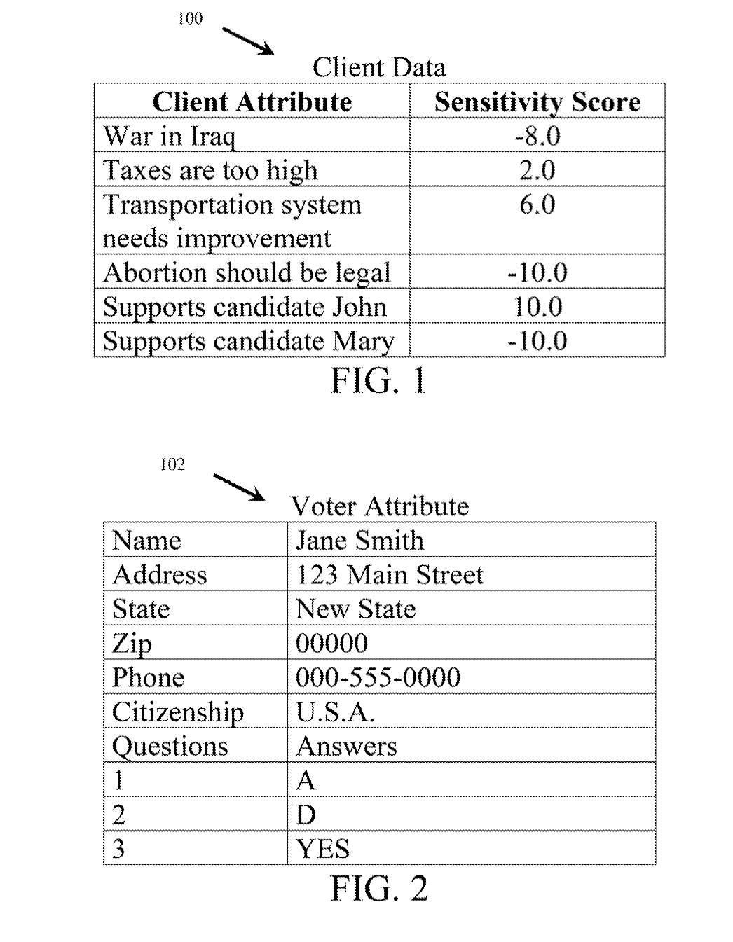

FIG. 1 illustrates an example of a client data 100. The client data is represented as a table in FIG. 1, but the client data 100 may be a multidimensional database having fields and data that are dependent on one or more fields and data. First column in FIG. 1 represents an example of client attributes. In FIG. 1, the client attributes represent examples of campaign issues. Client attributes may include demographic data about the client. Second column in FIG. 1 illustrates examples of sensitivity scores associated with each client attribute. The sensitivity scores in FIG. 1 are examples which represent quantized values indicating where the client's political stance may be. For example, the first client attribute in FIG. 1 is labeled “War in Iraq” and the client's sensitivity score associated with “War in Iraq” is “−8.0.” The range of sensitivity score may be formulated by using many different schemes. For example, a positive value may represent that the client supports or agrees with the client attribute associated with the sensitivity score. For example, a negative value may represent that the client is against or disagrees with the client attribute associated with the sensitivity score. Further, for example, the magnitude of a value of the sensitivity score may represent how strong the client's position on the associated client attribute may be. Referring again to the example in FIG. 1, the client data 100 includes the client attribute labeled “War in Iraq” and associated sensitivity score of “−8.0.” This may represent that the client's political view on “War in Iraq” is that the client is against “War in Iraq” because the sensitivity score is a negative value. Further, the magnitude of the sensitivity score in the example may have a maximum allowable magnitude of 10.0. Accordingly, the value of the sensitivity score may be considered to be strong. Thus, the client's political stance on the issue or client attribute of “War in Iraq” may be that the client strongly disagrees with the “War in Iraq.” Reversing the above steps would be an example of how a client may translate a political view into a client attribute and associated sensitivity score.

Example sensitivity scores in FIG. 1 are base ten numerical values. However, sensitivity scores may be represented in any format that may be understood by a person and/or a machine. For example, in other embodiments, sensitivity score may be represented by binary values or hexadecimal values or other values having different bases. Sensitivity scores may be multidimensional. Sensitivity scores may be resulting values of functions, the functions being an algorithm using other variables. Examples of other variables may include one or more sensitivity scores associated with other client attributes. Other variables may include variables that are not part of a client data 100.

FIG. 2 illustrates an example of a voter attribute 102. One or more voter attribute 102 may be stored as a set of data in a database. The example of the voter attribute 102 in FIG. 2 includes voter identification. Examples of voter identification include names, serial numbers, or other schemes of identifying the person. Examples of voter demographic data is also included in the voter attribute 102 in FIG. 2. Voter demographic data may include zip code, citizenship, age, race, religious affiliation, sex, and other information. Voter attribute 102 may also include one or more questions and/or answers. The example voter attribute 102 in FIG. 2 includes three questions and three answers associated with the questions. The questions may be from polls taken from a web page or in person. Voter attribute 102 may be gathered from publicly available information databases. Voter attribute 102 may also be gathered, or data-mined, for example and not limited to from sources on the internet. Examples of sources on the internet are social networking sites, personal networking sites, blogs, internet webpage registrations, and other sources that are accessible via the internet. Voter attribute 102 may also be provided or purchased from companies. The information gathered may be kept in separate databases and evaluated individually. The information gathered may be merged into a new database. The information gathered may be used to update an existing database. The information gathered may be cross-referenced, linked, and/or associated with one or more pieces of other information. Information may also be gathered in person at gatherings or by door-to-door political activist who may ask several questions to a voter. Following are examples of questions that may be asked:

Question 1: Which issue do you believe is the most important facing the nation today? Select one answer:

A—War in Iraq

B—Immigration

C—Taxes

D—Abortion

Question 2: How do you feel about candidate John's position on the issue you selected as the most important in Question 1?

A—Strongly Oppose

B—Oppose

C—Support

D—Strongly Support

Question 3: Have you donated or contributed to candidate John's campaign?

YES—or—NO

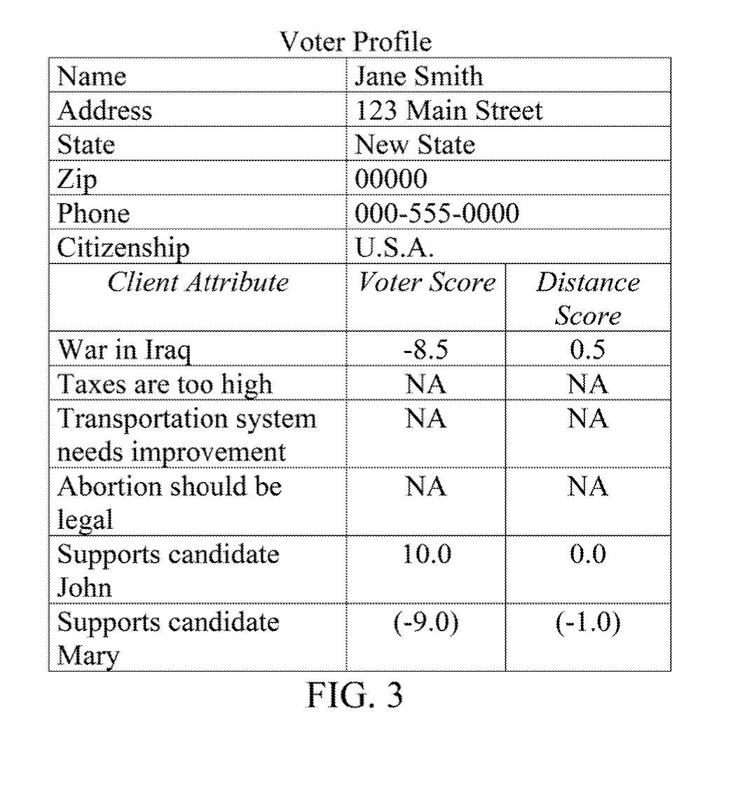

Still referring to FIG. 2, Question 1 may be associated with several of client attributes. Further, the answer from Question 1 and Question 2 may be used to determine what the voter's position may be on the client attribute. In the example illustrated in FIG. 2, the voter selected answer A for Question 1 and answer D for Question 2. Accordingly, the embodied method would determine from these sets of information that the voter has a matching client attribute labeled “War in Iraq” and the voter “strongly support candidate John's position” on the client attribute. Next, a step for translating or converting the substantive value from the answer into a quantitative value is performed. The term translate or translating is defined as to convert or converting a value or information into another form. For example, a value of text may have a substantive message which can be translated or converted into a numerical value according to a predetermined or dynamic set of criteria. Criteria may be a list or a chart. Criteria may be a function, a logic sequence, or an algorithm. The resulting quantitative value is a voter score associated with the client attribute. For example, the substantive value of “strongly support candidate John's position on the issue of War in Iraq” may be translated to a voter score of “−8.5” as illustrated in FIG. 3. The example voter score of “−8.5” results from a predetermined logic sequence wherein answer A to Question 1 and answer D to Question 2 are considered.

Referring to FIG. 2 again, it is illustrated therein that Question 3 has an answer of “YES.” For example, Question 3 may be associated with client attribute labeled “Supports candidate John” shown in FIG. 1. Accordingly, the answer of “YES” may be converted to a quantitative value using a logic sequence such that the voter score for the client attribute “Supports candidate John” has the value “10.0” as illustrated in FIG. 3.

Further, Question 3 may also be associated with client attribute labeled “Supports candidate Mary” shown in FIG. 1. For example, if a logic sequence or algorithm includes information that both candidate John and candidate Mary are running for the same position and that there are various reasons and factors that indicate there is a political difference or differences between candidate John and candidate Mary, information regarding a voter's answer to Question 3 may have some associative value to whether the voter supports candidate Mary or not. For example, client data illustrated in FIG. 1 shows that the client has a sensitively score of −10.0 for “Supports candidate Mary,” which indicates that the client strongly opposes candidate Mary. The voter “supports candidate John” and from at least these two pieces of information, it may be possible to predict how the voter may answer to a question “Do you support candidate Mary?” This prediction is possible even if such question or related question is not asked of the voter. If one or more related questions are asked and answered by the voter, the prediction value may also be used in a logic sequence or algorithm to determine a voter score. For example, FIG. 3 illustrates that it is predicted that the voter may have a voter score of −9.0 on the client attribute labeled “Supports candidate Mary” even though the voter was not directly asked whether the voter supports candidate Mary in a form of a question. The quantitative value of the voter score may be calculated and/or determined by using many methods, including variables or information that may not be part of the client attribute and/or the database. Predicted voter scores may be derived from using information such as voter demographic data.

It is also possible and preferable that more than one question may be associated with a particular client attribute. It is also possible and preferable that more than one client attribute may be associated with a question. If there are numerous questions that are associated with a particular candidate attribute, the quantitative values may be combined to a single value or voter score. The method of combining the quantitative values into a voter score may be as simple as averaging the quantitative values. Alternatively, a more complex algorithm may be used to combine the quantitative values into a voter score.

FIG. 3 shows an embodied Voter Profile table showing as an example how a set of distance scores may be determined. A distance score is defined as a quantifiable value that indicates how close a voter's view and a client's view may be on a particular issue represented by a client attribute. For example, a voter score may be subtracted from a client's sensitivity score for the matching client attribute. FIG. 3 illustrates this example, wherein the voter score of −8.5 is subtracted from client's sensitivity score of −8, resulting in a distance score of 0.5. In this particular example, the logic sequence and/or algorithm is predetermined such that closer the distance score is to 0, closer a voter's view is to a client's view on a particular issue represented by a client attribute. A positive distance score may represent that a voter's view is stronger than a client's view, while a negative distance score may represent that a client's view is stronger than a voter's view. However, these schemes and ranges are only provided as an example, and other more complex methods may be utilized to achieve a similar result. Accordingly, in the example illustrated in FIGS. 1-3, it can be determined that the voter Jane Smith's view and the client's view on the issue of War in Iraq are very similar.

A distance score associated with a client attribute may also be predicted using a logic sequence or algorithm using various pieces of information, such as but not limited to, a predicted voter score. An example of a predicted distance score is illustrated in FIG. 3, wherein it is predicted that Jane Smith's view on candidate Mary is similar to those of the client, as the predicted distance score is calculated to be −1.0. Predicted distance score may be understood in the same or a different way as distance scores.

During the lifespan of a voter, political candidate, and/or political issue, there may be changes. Changes may be caused by, for example, new information and/or reevaluation of old information. Accordingly, for example, a voter may have had a view that was ranked with a voter score of −10.0 five years-go, but today that same voter may have a view that is ranked with a voter score of 5.0. If an election is to happen two years from today, it would be a benefit to be able to predict what the voter score may be for the same voter two years from today. Such a prediction is possible using the method disclosed herein. Generally, a first score and a second score are used in a prediction algorithm to generate a third score. This third score is a prediction score. For example, for each voter a voter profile is associated with an identification data, such that every time a voter profile is changed, altered, and/or updated, the previous voter profile is stored separately. An example of an identification data may be a date-stamp, or a sequential numerical value. With a history of voter scores for a particular voter, a mathematical prediction algorithm may be used to predict a future voter score. It is also possible to use multiple voter scores to create a prediction voter score for a client criteria that had not existed in previous databases. For example, if a new client criteria was added recently because of new information, it may be possible to create an association between one or more old client criteria and the new client criteria. Accordingly, old voter scores for the old client criteria may be used to generate a historical voter scores and then apply a mathematical prediction algorithm to predict a future voter score. A voter profile is a collection of information including voter score and voter identification data. A voter profile report is an output of one or more voter profile. A voter profile report may be in a searchable format. A voter profile and voter profile report may be in storable in an electronic format.

Using the above methods, a targeted message report may be prepared for a specific individual voter. From a voter score and/or distance score, an evaluation can be made as to whether or not an issue related to a client attribute may be a topic to be discussed with the voter associated with the voter score and/or distance score. For example, from the example of Jane Smith provided above and in FIGS. 2-3, it may be evaluated that information regarding a client's view on the topic of “War in Iraq” may be better than the topic of Tax reform. Further, from evaluating the voter score and/or distance score on the issue of “War in Iraq” a particular message may be selected from a group of possible messages for delivery. For example, one or more messages on a particular issue related to a client attribute may be provided. Along with the messages, a logic sequence, algorithm, or a predetermined selection criteria may be provided to evaluate which message or messages should be selected for which voter score and/or distance score. If a voter score is within a certain predetermined range of the sensitivity score, then the voter score may be considered to be a match score. Alternatively, if a voter score is the same as the sensitivity score, the voter score may be considered a match score. The determination of a match score is dynamic and may change according to the particular needs of a client. A match score may also be determined by comparing a distance score and the sensitivity score or other values. In addition or alternatively, a logic sequence, algorithm, or a predetermined selection criteria may be provided to evaluate which message or messages should be selected for which voter score range and/or distance score range. For example, Jane Smith, who has a distance score of 0.5 on the client attribute, “War in Iraq” may receive a message prepared by a client that is associated with a distance score range of −1.0 to 1.0, while Dan Johnson, who has a distance score of 5.0 on the same client attribute may receive a different message, a message prepared by a client that is associated with a distance score range of 4.0 to 5.5. A message may be predetermined by multiple voter scores and/or distance scores, such that a multi-dimensional algorithm or database may be required to select a targeted message report for a specific voter. A targeted message report may be in a form of a letter, e-mail, text-message, or other forms of communication. Further, different targeted messages may be combined and/or compiled to form a targeted message report that is specifically designed for a particular voter.

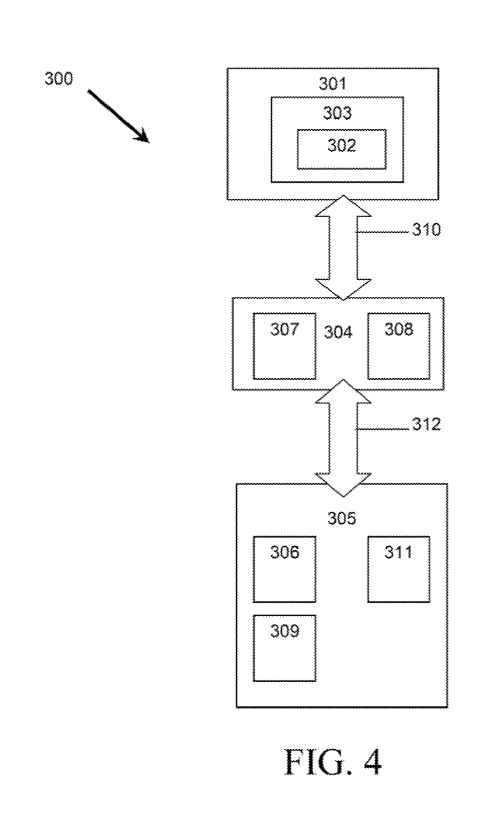

FIG. 4 is an embodiment of a system 300 for generating a voter profile. The embodiment provides a user interface 302 on a display device 303 of a remote computer 301, wherein the user interface 302 is in accordance with the display data sent from the front-end server 304. The display data may be provided via a network 310. An example of a network is the internet. An example of such a user interface 302 is a webpage. A dedicated client for the remote computer 301 may also be used. A user interface 302 for a personal mobile device or cellular phone may also be used. FIG. 4 shows an embodiment of a system 300 that includes data server 305 that includes a database management component 306 for managing electronic databases, a profile generation scheme 307 for generating one or more voter profiles, a scoring scheme 308 for translating an answer to a voter score, a voter input interface for receiving input from a user interface. Optionally, a data-mining scheme for gathering data may be included. One or more schemes listed above may be provided by a front-end server 304 or by a data server 305 or a combination thereof. The front-end server 304 and the data server 305 are connected for communication via a network 312. The data server 305 includes a database engine 311. A Database sequestration scheme may also be included in the data server as a part of the database engine 311. A database sequestration scheme is configured to store a set of client data separately from another set of client data. Such scheme may be via using separate computer readable memory, such as, virtual drives or physically separated drives. Other sequestration schemes are also possible where specific dataports for network traffic are specifically assigned to specific virtual machines or programs running programs accessing different client data. The system may also include a message server 400, wherein the data server 305 communicates the voter profile to the message server 400 and the message server 400 generates a targeted message report using any of the methods or combinations of methods disclosed above.

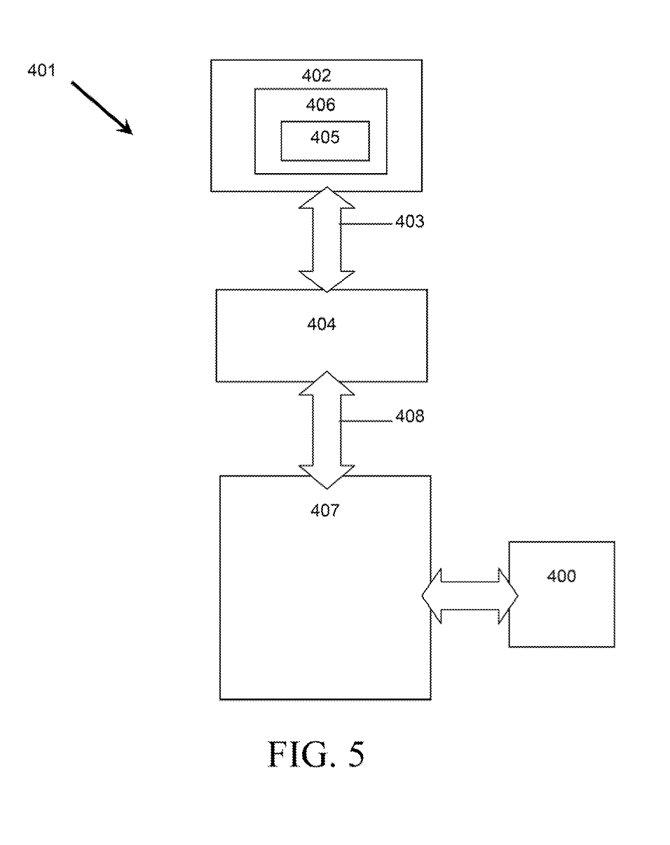

FIG. 5 shows another embodiment wherein the message server 400 is included in the system 401. For example, a user using a remote computer 402 connected to the internet 403 accessing a front-end server 404 to interact with a user interface 405 displayed on the display device 406 provided by the front-end server 404. The front-end server 404 communicates with the data server 407 via a network 408 and the data server 407 performs functions necessary to generate a voter profile, according to one or more methods disclosed above. Then, the data server 407 communicates the voter profile to the message server 400 and the message server 400 generates a targeted message report using any of the methods or combinations of methods disclosed above.

A preferred embodiment has been described for illustrative purposes. Those skilled in the art will appreciate that various modifications and substitutions are possible without departing from the scope of the invention, including the full scope of equivalents thereof.

What is claimed is:

1. A method of generating a voter profile, comprising:
storing a client data on a computer readable medium,
wherein the client data includes a client attribute and a sensitivity score;
storing a database on the computer readable medium,
wherein the database includes a set of data,
wherein the set of data includes a voter attribute,
wherein the voter attribute includes a voter identification, a question, and an answer;
creating an association between the client attribute and the question;
storing the association on the computer readable medium;
translating the answer into a voter score;
storing a computer instruction on the computer readable medium,
wherein the computer instruction includes an algorithm that uses the voter score and the sensitivity score to calculate a distance score;
performing the computer instruction of the algorithm to calculate the distance score;
generating a voter profile,
wherein the voter profile includes the voter identification, the client attribute, the voter score, and the distance score; and
storing the voter profile on the computer readable medium.

2. The method according to claim 1, further comprising:
storing a score range associated with the client attribute on the computer readable medium; and
storing a message associated with a match score on the computer readable medium,
wherein the score range includes a plurality of score values,
wherein the computer instruction further includes:
a step of comparing the voter score to the plurality of score values for determining the match score,
a step of determining the match score,
a step of storing the match score on the computer readable medium,
a step of associating the message to the voter identification, and
a step of generating a targeted message report,
wherein the targeted message report includes:
the voter identification, and
the message.

3. The method according to claim 1, further comprising:
storing a distance score range associated with the client attribute on the computer readable medium; and
storing a message associated with the distance score range on the computer readable medium,
wherein the computer instruction further includes:
a step of determining a match range by comparing the distance score to the distance score range,
a step of storing the match range,
a step of associating the message to the voter identification, and
a step of generating a targeted message report,
wherein the targeted message report includes:
the voter identification, and
the message.

4. The method according to claim 1, further comprising:
gathering a second set of data;
creating a second database from the second set of data,
wherein the second set of data includes a public attribute,
wherein the public attribute includes a public data field, and a public data value; and
translating the public data value into a second voter score,
wherein the voter profile further includes the second voter score.

5. The method according to claim 4, further comprising:
storing a score range associated with the client attribute on the computer readable medium,
wherein the score range includes a plurality of score values; and
storing a message associated with a match score on the computer readable medium,
wherein the computer instruction further includes:
a step of comparing the second voter score to the plurality of score values to determine the match score,
a step of associating the message to the voter identification, and
a step of generating a targeted message report,
wherein the targeted message report includes:
the voter identification, and
the message.

6. The method according to claim 4, further comprising:
creating an association between the question and the public data field; and
storing the association on a computer readable medium,
wherein the computer instruction further includes:
a step of determining a third voter score from the voter score and the second voter score,
wherein the voter profile further includes the third voter score.

7. The method according to claim 6, further comprising:
storing a score range associated with the client attribute on a computer readable medium,
wherein the score range includes a plurality of score values; and
storing a message associated with a match score on the computer readable medium,
wherein the computer instruction further includes:
a step of comparing the third voter score to the plurality of score values for determining the match score,
a step of determining the match score,
a step of associating the message to the voter identification, and
a step of generating a targeted message report,
wherein the targeted message report includes:
the voter identification, and
the message.

8. A method of generating a voter profile prediction, comprising:
storing a client data including a client attribute on a computer readable medium;
storing a database including a set of data on the computer readable medium,
wherein the set of data includes a voter attribute,
wherein the voter attribute includes:
a first score, and
a second score;
storing a score range associated with the client attribute on the computer readable medium,
wherein the score range includes a plurality of score values;
storing a message associated with a match score on a computer readable medium;
storing a computer instruction for voter profile prediction on the computer readable medium,
wherein the computer instruction includes:
a step of generating a third score from a prediction algorithm using the first score and the second score,
a step of creating an updated voter attribute from the voter attribute and the third score,
a step of generating the voter profile prediction from the updated voter attribute,
a step of comparing the third score to the plurality of score values to determine the match score, and
a step of generating a targeted message report,
wherein the targeted message report includes:
a voter identification, and
the message.

9. A system for generating a voter profile, comprising:
a data server; and
a front-end server that communicates a display data via a network to a remote computer,
wherein the remote computer includes a display device that displays a client interface in accordance to the display data,
wherein the client interface is configured to communicate client data and a voter profile request via the network to the front-end server,
wherein the front-end server communicates the voter profile request to the data server,
wherein the data server generates a voter profile and stores the voter profile on a computer readable medium.

10. The system according to claim 9,
wherein the data server includes the computer readable medium,
wherein the computer readable medium includes a computer program,
wherein the computer program includes a prediction algorithm,
wherein the prediction algorithm includes:
a step of generating a third score by using the first score and the second score,
a step of creating an updated voter attribute from a voter attribute and the third score,
a step of generating a voter profile prediction from the updated voter attribute, and
a step of comparing the third score to a plurality of score values to determine a match score.

11. The system according to claim 9, further comprising:
a message server that generates a targeted message report,
wherein the targeted message report includes:
a voter identification, and
a message,
wherein the data server communicates the voter profile to the message server.

12. The system according to claim 9, further comprising:
a database sequestration scheme configured to store a first client data separately from a second client data.
